(19) United States
(12) Patent Application Publication
(10) Pub. No.: US 2009/0242559 A1
(43) Pub. Date: Oct. 1, 2009

(54) Skin for member with skin, member with skin and process for manufacturing the same

(75) Inventors: Hiroki Mizoguchi, Aichi-ken (JP); Junichiro Kako, Aichi-ken (JP); Koichi Suzuki, Aichi-ken (JP); Eiichi Takahashi, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/382,439

(22) Filed: Mar. 17, 2009

(30) Foreign Application Priority Data
Mar. 27, 2008 (JP) 2008-83903

(51) Int. Cl. B65D 51/00; B68G 99/00

(52) U.S. Cl. 220/200; 29/91.5

(57) ABSTRACT

A member with skin includes a substrate, and a skin. The skin includes a covering portion for covering the substrate on the front surface's side, and an anchoring portion for engaging with the substrate's rear-surface periphery. The skin has a covering surface being formed as a concaved planar shape, and an exposed surface being formed as a convexed planar shape. The anchoring portion is disposed successively to the covering portion's periphery, and extends inward toward the covering portion. The skin is made of soft material, and is molded independently of the substrate. Before being assembled with the substrate, the skin includes the covering portion whose covering surface is formed as a convexed planar shape, and whose exposed surface is formed as a concaved planar shape, and the anchoring portion is placed more outward than the covering portion's periphery lies.

### INCORPORATION BY REFERENCE

The present invention is based on Japanese Patent Application No. 2008-83,903, filed on Mar. 27, 2008, the entire contents of which are incorporated herein by reference.

### BACKGROUND OF THE INVENTION

1. Field of the Invention

The present invention relates to a skin for member with skin, a member with skin, and a process for manufacturing the same. For example, a member with skin comprises a substrate, and a skin that has a covering portion and a curled portion. The skin's covering portion covers the substrate on a side of the substrate's front surface. The skin's curled portion engages with the substrate's rear-surface periphery.

2. Description of the Related Art

For example, Japanese Unexamined Patent Publication (KOKAI) Gazette No. 2004-129,744, and Japanese Unexamined Patent Publication (KOKAI) Gazette No. 2007-145,086 disclose a member with skin, respectively. A member with skin has been made by assembling a substrate and a skin that are molded independently of each other, and has been used for console box's lid, for instance.

FIGS. 13 and 14 are cross-sectional diagrams for illustrating a conventional member with skin. The conventional member with skin will be hereinafter described with reference to the drawings. The conventional member with skin comprises a substrate 101, and a skin 102. The skin 102 covers the substrate 101 on the front-surface side 115. Moreover, the periphery of the skin 102 is curled toward the rear surface 116 of the substrate 101. Of the parts of the skin 102, a part that covers the substrate 101 on the front-surface side 115 will be hereinafter referred to as a “covering portion 120,” and a part that is curled toward the rear surface 116 of the substrate 101 will be hereinafter referred to as a “curled portion 121.”

Note that, in the conventional member with skin, the curled portion 121 is fastened down onto the rear surface 116 of the substrate 101 with tucker pins 150. Accordingly, in order to assemble the skin 102 with the substrate 101, it has been necessary to hold the skin 102 against the substrate 101 on the front-surface side 115 and then to fasten the periphery of the skin 102, that is, the curled portion 121, down onto the rear surface 116 of the substrate 101 with the tucker pins 150 while not only pulling the curled portion 121 toward the rear surface 116 but also curling it around the periphery of the substrate 101. Consequently, in the course of manufacturing the conventional member with skin, it has been very troublesome to assemble the skin 102 with the substrate 101.

In the case where a soft material is used as a material for the skin 102 and the curled portion 121 is molded with die in such a shape that can engage with the rear-surface periphery of the substrate 101, it is believed that the operation of assembling the skin 102 with the substrate 101 would be easy compared with the case where the curled portion 121 is fastened down onto the rear surface 116 of the substrate 101 with the tucker pins 150 as described above.

However, as illustrated in FIG. 14, the curled portion 121 has a shape that makes undercut, because it extends inward from the periphery of the covering portion 120, that is, it extends toward the rear surface 116 of the substrate 101. Accordingly, it would be difficult and costly to pull out or separate the thus molded skin 102 from a molding die 160 for skin. Consequently, the molded skin 102 would be associated with such a problem that it is less likely to be manufactured inexpensively.

Moreover, the molding die 160 for molding such a type of skin 102 is required to be a dividable die that comprises the following sections: a section 161 for molding the inner sections of the skin 102, that is, of all the sections of the skin 102, the surface that faces the front surface 115 of the substrate 101, and the curled portion 121; and a section 162 for molding the outer side of the skin 102, that is, of all the sections of the skin 102, a surface that is exposed on the front side of a completed member with skin. Therefore, the skin 102 that is molded with such a molding die 160 for skin is provided with a parting line 128 at the boundary between the inner section and the outer section. Accordingly, the parting line 128 of the skin 102 has come to be visible on the outside to a finished member with skin. Consequently, there might arise such a problem that the parting line 128 has impaired the decorativeness of the thus manufactured member with skin.

In addition, when the skin 102 is made of a soft material, it is required to carry out the following: pulling the skin 102 to open up the curled portion 121 to the front surface 115 of the substrate 101; and then engaging the opened-up curled portion 121 with the rear-surface periphery of the substrate 101. As a result, not only the operation of assembling the skin 102 with the substrate 101 would be troublesome, but also would result in such a problem that a member with skin is likely to be manufactured expensively.

### SUMMARY OF THE INVENTION

The present invention has been developed in view of such circumstances. It is therefore an object of the present invention to provide the following: a process for manufacturing member with skin, process which makes it possible to less expensively manufacture a member with skin that exhibits good decorativeness; a member with skin, member which is not only good in terms of decorativeness but also can be manufactured inexpensively; and a skin, which produces upgraded assemblage readiness in addition to exhibiting good decorativeness and being manufactured at reduced cost. In the following descriptions on the present invention, note that a part or section, which corresponds to the curled portion 121 in the conventional member with skin, will be hereinafter referred to as an “anchoring portion.”

A process for manufacturing member with skin according to the present invention, process which can solve the above-described problems, is a process for manufacturing member with skin, the member comprising:

a substrate comprising a front surface, and a rear surface being disposed back-to-back to the front surface and having a periphery;

a skin comprising a covering portion for covering the substrate on a side of the front surface, and an anchoring portion for engaging with the periphery of the rear surface of the substrate;

the covering portion having a covering surface being formed as a concaved planar shape and facing the front surface of the substrate, an exposed surface being formed as a convexed planar shape and being disposed back-to-back to the covering surface, and a periphery;

the anchoring portion being disposed successively to the periphery of the covering portion, and extending inward toward the covering portion; and

the skin being made of soft material, and being molded independently of the substrate;

the process comprises the steps of:

molding the skin, wherein the skin is molded so that the covering surface is formed as a convexed planar shape, the exposed surface is formed as a concaved planar shape and the anchoring portion is placed more outward than the periphery of the covering portion lies, and a molding die for molding the skin is used, the molding die being provided with a die-parting line at a part thereof for molding the anchoring portion at least; and

assembling the skin with the substrate, wherein the skin undergoes concavity/convexity reversal so that the covering surface is formed as a concaved planar shape, the exposed surface is formed as a convexed planar shape and the anchoring portion extends inward from the periphery of the covering portion.

The process for manufacturing member with skin according to the present invention can preferably be provided with either one of following optional features (1) through (5). It is more preferable that the present process for manufacturing member with skin can be provided with a plurality of following optional features (1) through (5).

(1) In the present manufacturing process, the skin can preferably be made of at least one soft material being selected from the group consisting of thermoplastic polyolefine (TPO), polyvinyl chloride (PVC) and thermoplastic polyurethane (TPU).

(2) In the present manufacturing process, the anchoring portion can preferably be molded as a configuration that extends outward from the periphery of the covering portion at the step of molding the skin.

(3) In the present manufacturing process, the member can preferably further comprise an inner member being independent of the substrate and the skin; and the anchoring portion of the skin can preferably be held between the inner member and the substrate.

(4) In the present manufacturing process, the member can preferably further comprise: a space disposed between the skin and the substrate; and an elastically-deformable cushioning member intervening between the skin and the substrate in the space.

(5) In the present manufacturing process, the cushioning member can preferably be molded integrally with the skin at the step of molding the skin.

A member with skin according to the present invention makes it possible to solve the above-described problems, and comprises:

a substrate comprising a front surface, and a rear surface being disposed back-to-back to the front surface and having a periphery;

a skin comprising a covering portion for covering the substrate on a side of the front surface, and an anchoring portion for engaging with the periphery of the rear surface of the substrate;

the covering portion having a covering surface being formed as a concaved planar shape and facing the front surface of the substrate, an exposed surface being formed as a convexed planar shape and being disposed back-to-back to the covering surface, and a periphery;

the anchoring portion being disposed successively to the periphery of the covering portion, and extending inward toward the covering portion; and

the skin being made of soft material, and being molded independently of the substrate;

wherein, before being assembled with the substrate, the skin comprises:

the covering portion whose covering surface is formed as a convexed planar shape, and whose exposed surface is formed as a concaved planar shape; and

the anchoring portion being placed more outward than the periphery of the covering portion lies.

A skin for member with skin according to the present invention can solve the above-described problems. The present skin is for member with skin that comprises:

a substrate comprising a front surface, and a rear surface being disposed back-to-back to the front surface and having a periphery;

a skin comprising a covering portion for covering the substrate on a side of the front surface, and an anchoring portion for engaging with the periphery of the rear surface of the substrate;

the covering portion having a covering surface being formed as a concaved planar shape and facing the front surface of the substrate, an exposed surface being formed as a convexed planar shape and being disposed back-to-back to the covering surface, and a periphery;

the anchoring portion being disposed successively to the periphery of the covering portion, and extending inward toward the covering portion; and

the skin being made of soft material, and being molded independently of the substrate;

wherein, before being assembled with the substrate, the present skin comprises:

the covering portion whose covering surface is formed as a convexed planar shape, and whose exposed surface is formed as a concaved planar shape; and

the anchoring portion being placed more outward than the periphery of the covering portion lies.

Note that the present member with skin, and the present skin can preferably be provided with above-described optional feature (1).

A member with skin according to the present invention comprises a substrate, and a skin. The substrate comprises a front surface, and a rear surface having a periphery. The skin comprises a covering portion, and an anchoring portion. The covering portion is for covering the substrate on a side of the front surface. The anchoring portion is for engaging with the periphery of the substrate's rear surface. When the skin is assembled with the substrate (hereinafter referred to as “at the time of assemblage completion”), the covering portion has a concaved face (or covering surface) that faces the front surface of the substrate, and a convexed face (or exposed surface) that faces back-to-back to the covering surface. Moreover, at the time of assemblage completion, the exposed surface of the skin is placed on an outer side to the completed member with skin, and the covering surface is placed on an inner side to the completed member with skin. In addition, at the time of assemblage completion, the anchoring portion extends inward around the periphery of the substrate's rear surface and toward the skin's covering portion, and thereby engages with the periphery of the substrate's rear surface. Therefore, at the time of assemblage completion, the anchoring portion is also placed on an inner side in the finished member with skin.

In the present manufacturing process, the skin is molded as such a configuration that has undergone concavity/convexity reversal from that of the skin at the time of assemblage completion. Accordingly, at the time or step of molding, the skin comprises the exposed surface being formed as a concaved planar shape, and the covering surface being formed as a convexed planer shape. Moreover, the skin's anchoring portion is placed more outward than the periphery of the covering portion lies. Consequently, it is possible to provide the skin with a parting line on an outer side of the skin when it is being molded.

Moreover, when assembling the molded skin with the substrate, the molded skin undergoes the opposite concavity/convexity reversal. Accordingly, it is possible to place the parting line on an inner side of the skin. Consequently, the parting line becomes invisible on an outer side to the completed member with skin. Therefore, the process for manufacturing member with skin according to the present invention makes it possible to manufacture member with skin that is good in terms of decorativeness.

In addition, the skin is molded as such a configuration that has undergone concavity/convexity reversal from that of the skin at the time of assemblage completion, as described above. Accordingly, when the skin is molded, the skin's anchoring portion is placed more outward than the periphery of the covering portion lies. Consequently, the anchoring portion does not make a configuration that results in undercut. Therefore, the process for manufacturing member with skin according to the present invention makes it possible to manufacture skin readily and inexpensively.

Moreover, when the step of molding is finished, not only the skin's anchoring portion is placed more outward than the covering portion lies, but also it has been opened up to the covering portion already. When the skin is assembled with the substrate under such circumstances, it is possible to engage the anchoring portion with the substrate's periphery without ever opening up the anchoring portion. Therefore, the process for manufacturing member with skin according to the present invention enables an assembly worker or robot to readily assemble the skin with the substrate.

The process for manufacturing member with skin according to the present invention that is provided with above-described optional feature (1) uses at least one member being selected from the group consisting of TPO, PVC and TPU, one of elastomers (i.e., materials that are capable of deforming elastically), as the soft material. Accordingly, the resulting skin can undergo the opposite concavity/convexity deformation more readily, and thereby the readiness of assembling the skin with the substrate improves furthermore. Moreover, if such is the case, the skin can keep the configuration at the time of assemblage completion stably as far as it is not subjected to external force. Consequently, once the skin is assembled with the substrate, it is less likely to come off from the substrate. Therefore, the process for manufacturing member with skin according to the present invention that is provided with above-described optional feature (1) not only makes the operation of assembling the skin with the substrate more readily, but also makes it possible to manufacture member with skin much less expensively.

In accordance with the process for manufacturing member with skin according to the present invention that is provided with above-described optional feature (2), the anchoring portion is molded as a configuration that extends outward from the periphery of the covering portion at the step of molding the skin. As a result, it is possible to make the distance between the anchoring portion's outer end and the covering portion's periphery greater. Accordingly, when the molding die for molding the skin is provided with a die-parting line at a position thereof that corresponds to the anchoring portion's outer end, it is possible to greatly separate the resulting parting line, which appears on the molded skin, away from the covering portion's periphery. Consequently, it is possible to place the parting line on an inner side of the skin with higher reliability in the completed member with skin. Therefore, it is possible for the process for manufacturing member with skin according to the present invention that is provided with above-described optional feature (2) to highly reliably make a parting line, which appears on the molded skin, invisible on an outer side to the completed member with skin. All in all, the process for manufacturing member with skin according to the present invention that is provided with above-described optional feature (2) enables manufacturers to manufacture member with skin that demonstrates good decorativeness.

Moreover, it is possible to make an angle that the anchoring portion and the covering portion's periphery make greater, because the anchoring portion is molded as a configuration that extends outward from the covering portion's periphery. Accordingly, since the process for manufacturing member with skin according to the present invention that is provided with above-described optional feature (2) enables the anchoring portion to open up greatly to the covering portion at the skin-molding step, an assembly worker or robot can engage the anchoring portion with the substrate's periphery readily at the assembling step. Consequently, the process for manufacturing member with skin according to the present invention that is provided with above-described optional feature (2) enables an assembly worker or robot to assemble the skin with the substrate with ease.

The process for manufacturing member with skin according to the present invention that is provided with above-described optional feature (3) makes it possible to fasten the skin's anchoring portion firmly, thereby making it possible to manufacture member with skin that is much better in terms of decorativeness.

In accordance with the process for manufacturing member with skin according to the present invention that is provided with above-described optional feature (5), it is possible to give the completed member with skin a sense of soft usability by means of the cushioning member.

The process for manufacturing member with skin according to the present invention that is provided with above-described optional feature (5) makes it possible to reduce the man-hour requirement for manufacturing member with skin, thereby enabling manufacturers to manufacture member with skin inexpensively, because the cushioning member and the skin are molded integrally at the step of molding the skin. Moreover, as described above, the skin is made of soft material so that it is capable of deforming elastically. Accordingly, it is possible to use the same soft material as that makes the skin for the cushioning member and then to mold the cushioning member and skin more integrally. Therefore, the process for manufacturing member with skin according to the present invention that is provided with above-described optional feature (5) enables manufacturers to manufacture member comprising such a cushioning member more inexpensively

A member with skin according to the present invention comprises the skin whose configuration at the time of assemblage completion has undergone concavity/convexity reversal from that at the time of molding. Further, the skin can readily undergo the opposite concavity/convexity reversal when being assembled with the substrate, because it is made of soft material. Therefore, when manufacturing the present member with skin, an assembly worker or robot can assemble the skin with the substrate with ease. Thus, it is possible to manufacture the present member with skin at reduced cost. Furthermore, since the present member with skin comprises the skin whose concavity/convexity configuration is reversed before being assembled with the substrate, it is possible to mold the skin's anchoring portion as such a shape that does not make any undercut configuration at the time of molding. This advantageous construction also makes it possible to manufacture the present member with skin less expensively. Moreover, in the manufacture of the present member with skin, an assembly worker or robot reverses the skin's molded concavity/convexity configuration so that the concavity turns into a convexity, and vice versa, prior to the assemblage with the substrate, and then the assembly worker or robot assembles the reversed skin with the substrate. That is, a parting line that the skin is provided with is placed eventually on an inner side of the finished present member with skin. As a result, the completed present member with skin demonstrates good decorativeness.

A skin according to the present invention has a molded configuration that undergoes concavity/convexity reversal before being assembled with a substrate. Moreover, when the present skin is assembled with a substrate, the skin's concaved configuration can be reversed to a convexed configuration readily, and its convexed configuration can be reversed to a concaved configuration readily. Accordingly, the present skin exhibits assemblage readiness to substrate. Moreover, the present skin comprises an anchoring portion that does not make any undercut configuration upon molding. In addition, the present skin is provided with a parting line that comes inside the molded present skin upon assembling. Consequently, not only the present skin can be manufactured inexpensively, but also it is good in terms of decorativeness.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is an explanatory perspective diagram for illustrating a manufacturing process for member with skin according to Example No. 1 of the present invention.

FIG. 2 is another explanatory perspective diagram for illustrating the present manufacturing process for member with skin according to Example No. 1.

FIG. 3 is still an explanatory cross-sectional diagram for illustrating the present manufacturing process for member with skin according to Example No. 1.

FIG. 4 is still another explanatory cross-sectional diagram for illustrating the present manufacturing process for member with skin according to Example No. 1.

FIG. 5 is still another explanatory cross-sectional diagram for illustrating the present manufacturing process for member with skin according to Example No. 1.

FIG. 6 is an explanatory cross-sectional diagram for illustrating a manufacturing process for member with skin according to Example No. 2 of the present invention.

FIG. 7 is another explanatory cross-sectional diagram for illustrating the present manufacturing process for member with skin according to Example No. 2.

FIG. 8 is an explanatory cross-sectional diagram for illustrating a manufacturing process for member with skin according to Example No. 3 of the present invention.

FIG. 9 is another explanatory cross-sectional diagram for illustrating the present manufacturing process for member with skin according to Example No. 3.

FIG. 10 is an explanatory cross-sectional diagram for illustrating a manufacturing process for member with skin according to Example No. 4 of the present invention.

FIG. 11 is another explanatory cross-sectional diagram for illustrating the present manufacturing process for member with skin according to Example No. 4.

FIG. 12 is still another explanatory cross-sectional diagram for illustrating the present manufacturing process for member with skin according to Example No. 4.

FIG. 13 is an explanatory cross-sectional diagram for illustrating a conventional manufacturing process for member with skin.

FIG. 14 is another explanatory cross-sectional diagram for illustrating the conventional manufacturing process for member with skin.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

### EXAMPLES

Hereinafter, manufacturing processes for member with skin according to the present invention will be described with reference to specific examples.

### Example No. 1

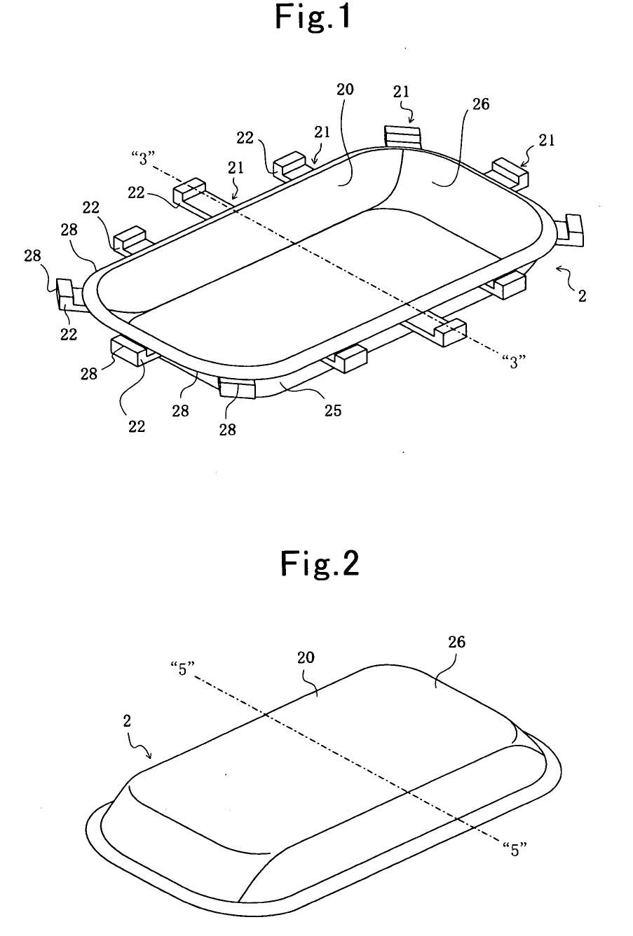

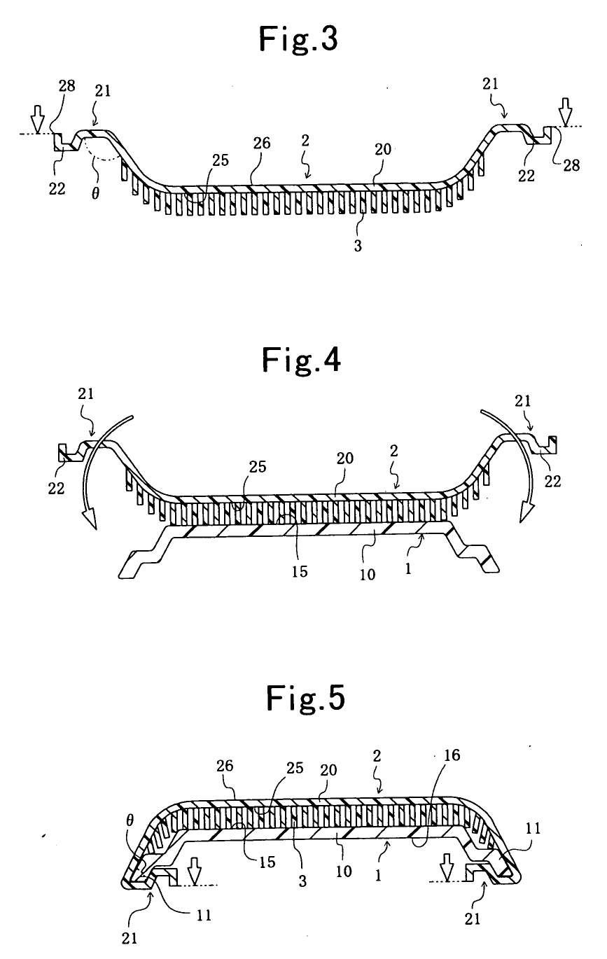

A process for manufacturing member with skin according to Example No. 1 of the present invention is provided with above-described optional features (1), (2), (4) and (5). Moreover, a member with skin according to Example No. 1 is directed to the present member with skin that is provided with above-described optional feature (1). In addition, a skin according to Example No. 1 is directed to the present skin that is provided with above-described optional feature (1). FIGS. 1 through 5 show explanatory diagrams for illustrating the process for manufacturing member with skin according to Example No. 1. Specifically, FIG. 1 is a perspective view for schematically illustrating a skin at a step of molding. FIG. 2 is a perspective view for schematically illustrating the skin at a step of assembling. FIG. 3 is a cross-sectional view for schematically illustrating how the skin shown in FIG. 1 appears when it is cut with the imaginary chain line “3”-“3” in FIG. 1. FIG. 4 is a cross-sectional view for schematically illustrating how the skin appears when it is assembled with a substrate. FIG. 5 is a cross-sectional view for schematically illustrating a member with skin that is manufactured by the present process for manufacturing member with skin according to Example No. 1, and is taken perpendicularly to the imaginary chain line “5”-“5” in FIG. 2.

As illustrated in FIG. 5, a member with skin that is manufactured by a manufacturing process according to Example No. 1 (hereinafter, simply referred to as a “member with skin according to Example No. 1”) comprises a substrate 1, a skin 2, and a cushioning member 3.

The substrate 1 is made of a material such as acrylonitrile-butadiene-styrene (ABS) or polypropylene (PP). As illustrated in FIG. 5, the substrate 1 comprises a substrate body 10, and a substrate-side engager 11. The substrate body 10 is formed as a convexed configuration (or an inverted substantially-boxed shape). As shown in FIG. 5, the substrate-side engager 11 extends outward from the periphery of the substrate body 10 to make the periphery of the substrate 1. The substrate body 10 has a front surface 15 that is formed as a convexed planar shape. Moreover, the substrate body 10 has a rear surface 15 that is formed as a concaved planar shape.

As illustrated in FIG. 1, the skin 2 comprises a covering portion 20, and twelve anchoring portions 21. The covering portion 20 has a covering surface 25, and an exposed surface 26. The covering surface 25 makes a surface that faces the front surface 15 of the substrate body 10 in the substrate 1 at the time of assemblage completion, as shown in FIGS. 2 and 5. The exposed surface 26 makes a surface that is disposed back-to-back to the covering surface 25 and is exposed on the front side of the resulting member with skin at the time of assemblage completion, as shown in FIGS. 2 and 5. As illustrated in FIGS. 1 and 3, the exposed surface 26 has a concaved planar shape at the molding step, and the covering surface 25 has a convexed planar shape at the molding step. Thus, the covering portion 20 has a concaved configuration as a whole at the molding step. On the contrary, as shown in FIGS. 2 and 5, the exposed surface 26 has a convexed planar shape at the time of assemblage completion, and the covering surface 25 has a concaved planar shape at the time of assemblage completion. Thus, the covering portion 20 has a convexed configuration as a whole at the time of assemblage completion.

As illustrated in FIG. 1, the respective anchoring portions 21 are disposed one after another on the periphery of the covering portion 20 in the skin 2, and are separated away from each other in the peripheral direction of the covering portion 20. As shown in FIGS. 1 and 3, at the molding step, the respective anchoring portions 21 are formed as a strip-shaped configuration that extends outward from the periphery of the covering portion 20. On the contrary, at the time of assemblage completion illustrated in FIG. 5, the respective anchoring portions 21 are formed as a strip-shaped configuration that extends inward from the periphery of the covering portion 20. Moreover, the respective anchoring portions 21 have a protruded end 22 that is formed as a hook shape. In addition, the skin 2 is made of thermoplastic polyolefine (TPO), polyvinyl chloride (PVC) or thermoplastic polyurethane (TPU), a soft material, and is made by injection molding independently of the substrate 1.

In the member with skin according to Example No. 1, the cushioning member 3 is made by molding integrally with the skin 2. As illustrated in FIG. 3, the cushioning member 3 comprises a plurality of pillar-shaped portions that protrude downward from the covering surface 25 of the skin 2. The cushioning member 3 is made of the same material as the material that makes the skin 2, and is made by injection molding at the same time as molding the skin 2.

Hereinafter, a manufacturing process for the member with skin according to Example No. 1 will be described in detail.

First of all, the skin 2 and cushioning member 3 were molded simultaneously by injection molding. As illustrate in FIG. 1, the exposed surface 26 of the skin 2 was formed as a concaved planar shape; the covering surface 25 was formed as a convexed planar shape; and the anchoring portions 21 extended outward from the periphery of the covering portion 20 in the skin 2; when the molding step was completed. Note that a not-shown molding die for the skin 2 and cushioning member 3 was provided with a die-parting line at a position that is designated with the blank arrows and dotted lines in FIG. 3, or it was dividable at the position. Consequently, as illustrated in FIGS. 1 and 3, the molded skin 2 was provided with a parting line 28 that coincided with the free end of the respective anchoring portions 21 and with the imaginary free-end periphery of the spaces between the neighboring anchoring portions 21 in the periphery of the covering portion 20. To put it differently, the parting line 28 was formed on an outer side in the molded skin 2, that is, it was formed flush with the top outer periphery of the molded skin 2, as shown in FIG. 3.

Next, the skin 2 with the as-molded configuration was put onto an assembly machine (not shown). Then, as illustrated in FIG. 4, the skin 2 was placed onto the substrate 1 while covering the front surface 15 of the substrate body 10 with the covering surface 25 of the skin 2 face-to-face. Thereafter, the assembly machine was actuated to have the skin 2 undergo concavity/convexity reversal. As a result, as illustrated in FIG. 5, the covering surface 25 of the skin 2 deformed from the convexed planar shape to a concaved planar shape, and the exposed surface 26 deformed from the concaved planar shape to a convexed planar shape. Moreover, the anchoring portions 21 deformed from the configuration that extended toward the outside of the skin 2 to a configuration that extended toward the inside of the skin 2, and thereby they curled up around and about the substrate-side engager 11 of the substrate 1. The skin 2 was thus assembled with the substrate 1 by means of this assembling step. In addition, the cushioning member 3 that protruded downward from the covering surface 25 of the skin 2 was held between the skin 2 and the substrate 1.

The manufacturing process for the member with skin according to Example No. 1 made it possible to provide the skin 2 with the parting line 28 that was disposed on the exterior of the skin 2 at the molding step and was then disposed on the interior of the skin 2 at the assembling step, because the skin 2 was molded as such a configuration that had undergone concavity/convexity reversal with respect to its configuration at the assembling step. Thus, the manufacturing process for the member with skin according to Example No. 1 made it possible to manufacture member with skin that demonstrated good decorativeness, because was is possible to put the parting line 28 in place at such a position that was invisible from the outside of the completed member with skin.

Moreover, it was possible to design the anchoring portions 21 as such a configuration that did not make any undercut at the molding step, because the anchoring portions 21 were molded as such a configuration that underwent concavity/convexity reversal to turn into the configuration at the assembling step. Therefore, the manufacturing process for the member with skin according to Example No. 1 enables manufacturers to manufacture the skin 2 readily and inexpensively, because it enables an assembly worker or robot to remove the skin 2 from the molding die for skin with ease.

In addition, it was possible to assemble the skin 2 with the substrate 1 easily, because the skin 2 was molded as a configuration that was capable of undergoing concavity/convexity reversal and was reversed to its final configuration during the assembling step. It is for the following reason that this advantage, the readiness in assemblage, can be produced.

As described above, in the manufacturing process for the member with skin according to Example No. 1, the anchoring portions 21 of the skin 2 are formed as a configuration that extends toward the outside of the covering portion 20 at the molding step, and is then deformed to a configuration that extends toward the inside of the covering portion 20 at the assembling step. Accordingly, the periphery of the covering surface 25 and the anchoring portions 21 make an angle θ that is an obtuse angle at the molding step as shown in FIG. 3, and that is an acute angle at the assembling step as shown in FIG. 5. Consequently, at the molding step, the anchoring portions 21 have already been opened up to such an extent that they can readily engage with the rear surface of the substrate-side engager 11, namely, the rear-surface periphery of the substrate 1, at the subsequent assembling step. Therefore, it becomes unnecessary to open up the anchoring portions 21 in the course of assembling the skin 2 with the substrate 1 after the molding step. Thus, the manufacturing process for the member with skin according to Example No. 1 makes it possible to assemble the skin 2 with the substrate 1 with ease.

Moreover, not only the skin 2 could undergo concavity/convexity reversal with ease but also it exhibited good configurational stability when no external load was applied to it, because it was made of soft material, such as TPO, PVC or TPU. The skin 2 that could readily undergo concavity/convexity reversal made the operation of assembling the skin 2 with the substrate 1 easy. Moreover, the assembled skin 2, namely, the skin 2 after having undergone concavity/convexity reversal, was less likely to deform back to the configuration at the molding step. Accordingly, the skin 2 that had been once assembled with the substrate 1 was less likely to come off from the substrate 1. Consequently, the manufacturing process for the member with skin according to Example No. 1 enables an assembly worker or robot to readily assemble the skin 2 with the substrate 1, and thereby enables manufacturers to reduce the cost for manufacturing member with skin.

In addition, the cushioning member 3 that was disposed in the space that intervened between the skin 2 and the substrate 1 was capable of giving the member with skin according to Example No. 1 a sense of soft usability, which derived from the elasticity of the cushioning member 3. Moreover, the cushioning member 3 was made of soft material, such as TPO, PVC or TPU, in the same manner as the skin 2, and was made by molding integrally with the skin 2. Accordingly, the cushioning member 3 could contribute to reducing the manufacturing man-hour requirement and manufacturing cost for member with skin, compared with the case of using a material that differs from the material for the skin 2 as a material for the cushioning member 3, and compared with the case of molding the cushioning member 3 independently of the skin 2. Consequently, the manufacturing process for the member with skin according to Example No. 1 makes it possible to manufacture member with skin less expensively.

Moreover, the protruded end 22 of the anchoring portions 21 was less likely to deform, because it was formed as a hook shape. Therefore, the anchoring portions 21 were less likely to disengage from the rear surface of the substrate-side engager 11. It follows that the skin 2 was less likely to come off from the substrate 1.

### Example No. 2

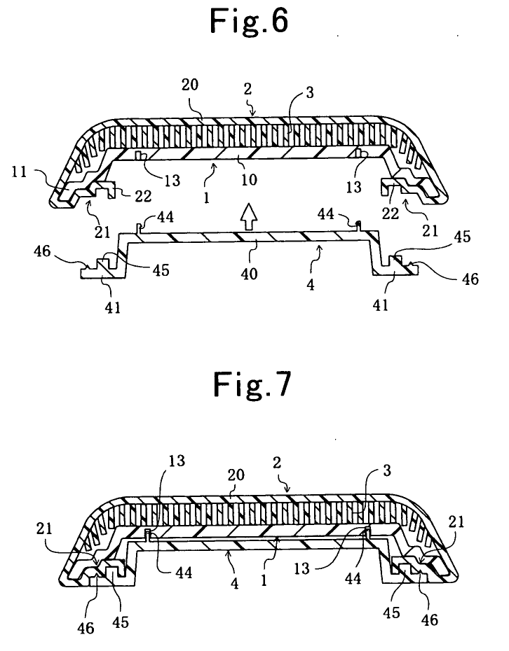

A process for manufacturing member with skin according to Example No. 2 of the present invention is provided with above-described optional features (1) through (5). Moreover, a member with skin according to Example No. 2 is directed to the present member with skin that is provided with above-described optional feature (1). In addition, a skin according to Example No. 2 is directed to the present skin that is provided with above-described optional feature (1). FIGS. 6 and 7 show explanatory diagrams for illustrating the process for manufacturing member with skin according to Example No. 2. Specifically, FIG. 6 is a cross-sectional view for schematically illustrating how a skin appears when it is assembled with a substrate. FIG. 7 is a cross-sectional view for schematically illustrating a completed member with skin that is manufactured by the present process for manufacturing member with skin according to Example No. 2.

A member with skin according to Example No. 2 comprises a substrate 1, a skin 2, a cushioning member 3, and an inner member 4. The substrate 1 is constructed in the same manner as that of the substrate 1 in the member with skin according to Example No. 1, except that the substrate-side engager 11 is formed differently from that in Example No. 1. That is, in Example No. 2, the substrate-side engager 11 extends outward from the periphery of the substrate body 10 in a stepwise manner. Thus, the step-shaped substrate-side engager 11 makes the periphery of the substrate 1. Moreover, the substrate body 10 is provided with a plurality of engagee holes 13 in the rear surface 16. The engagee holes 13 engage with engager claws 44 of the inner member 4 described later.

The skin 2 is constructed in the same manner as the skin 2 in the member with skin according to Example No. 1, except that the anchoring portions 21 are formed differently from those in Example No. 1. Specifically, although not being shown in the drawings, the respective anchoring portions 21 extend outward from the periphery of the covering portion 20 in a stepwise manner at the molding step. On the contrary, at the assembling step, the respective anchoring portions 21 extend inward from the periphery of the covering portion 20 in a stepwise manner, as illustrated in FIG. 6. Note that the respective anchoring portions 21 are similarly provided with a protruded end 22 that is formed as a hook shape.

The inner member 4 is made of ABS or PP, a hard material. The inner member 4 comprises an inner-member body 40, and an inner-member-side engager 41. The inner-member body 40 is formed as a convexed configuration or an inverted substantially-box-shaped configuration. The inner-member-side engager 41 extends outward from the periphery of the inner-member body 40. The inner-member body 40 is provided with a plurality of engager claws 44 that are formed as a hook shape. Note that, of all the sections of the inner-member body 40, the respective engager claws 44 are formed at sections that correspond to the respective engagee holes 13 of the substrate body 10.

The inner-member-side engager 41 comprises a plurality of bosses 45, and a plurality of studs 46. The respective bosses 45 are formed as a configuration that is die-symmetric to the hook-shaped protruded end 22 of the respective anchoring portions 21, or that reverses the hook shape of the protruded end 22. The respective studs 46 are disposed more outside than the respective bosses 45 lie, and are formed as a pointy-end configuration.

In the manufacturing process for member with skin according to Example No. 2, the step of assembling the skin 2 with the substrate 1 was carried out in the same manner as the manufacturing process for member with skin according to Example No. 1. Note herein that, in the manufacturing process for member with skin according to Example No. 2, the inner member 4 was further assembled with the rear side of the substrate 1 after the skin 2 had been assembled with the substrate 1. In this instance, as illustrated in FIG. 7, the engager claws 44 of the inner member 4 engaged with the corresponding engagee holes 13 of the substrate 1, respectively. The engagement between the engager claws 44 and the engagee holes 13 fastened the inner member 4 to the substrate 1 firmly.

Moreover, each of the bosses 45 of the inner member 4 went into the hook-shaped protruded end 22 of the respective anchoring portions 21, and each of the studs 46 of the inner member 4 bit into a section of all the anchoring portions 21 that was more outward and nearer to the covering portion 20 than the hook-shaped protruded end 22 lies. Thus, the inner member 4 and substrate 1 held the anchoring portions 21 between them.

In addition, of all the surfaces of the substrate 1, the surface that faced the bosses 45 of the inner member 4 was dented in a stepwise manner. The concavity/convexity configurations of the substrate 1 and inner member 4 enabled the substrate 1 and inner member 4 to hold the anchoring portions 21 between them stably.

In the manufacturing process for member with skin according to Example No. 2, not only the skin 2 was molded as a configuration that had undergone concavity/convexity reversal from the configuration at the time of completed assemblage, but also the skin 2 was assembled with the substrate 1 while subjecting the skin 2 to the opposite concavity/convexity reversal, in the same manner as the manufacturing process for member with skin according to Example No. 1. Therefore, the manufacturing process for member with skin according to Example No. 2 enables manufacturers to inexpensively manufacture member with skin that demonstrates good decorativeness. Moreover, not only the member with skin according to Example No. 2 was good in terms of decorativeness, but also it could be manufactured at reduced cost. In addition, not only the skin 2 according to Example No. 2 could be manufactured less expensively, but also it produced upgraded assemblage readiness to the substrate 1 as well as good decorativeness.

Moreover, in the manufacturing process for member with skin according to Example No. 2, the anchoring portions 21 of the skin 2 were held between the inner member 4 and the substrate 1. Accordingly, the skin 2 was much less likely to come off from the substrate 1. Consequently, the manufacturing process for member with skin according to Example No. 2 enables manufacturers to manufacture member with skin that demonstrates much better decorativeness.

### Example No. 3

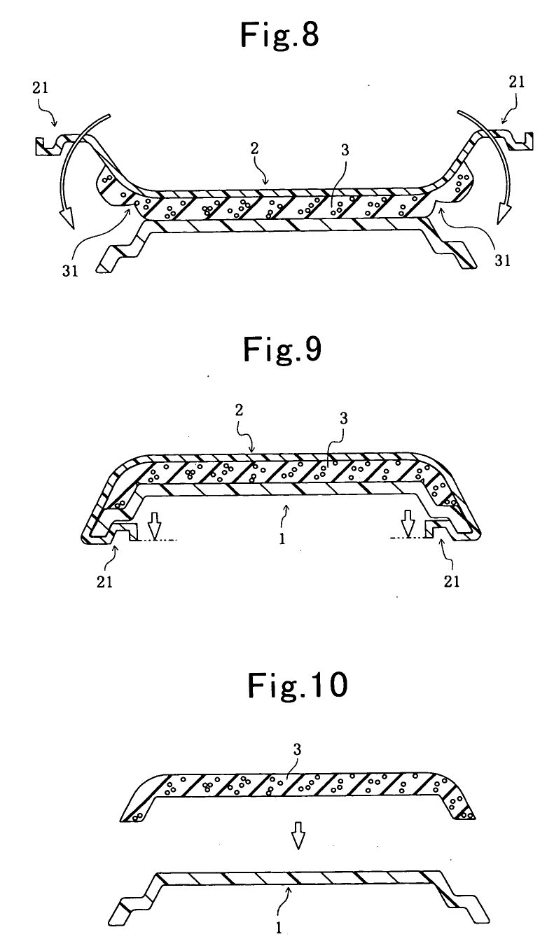

A process for manufacturing member with skin according to Example No. 3 of the present invention is provided with above-described optional features not only (1) and (2) but also (4) and (5). FIGS. 8 and 9 show explanatory diagrams for illustrating the present process for manufacturing member with skin according to Example No. 3. Specifically, FIG. 8 is a cross-sectional view for schematically illustrating how a skin appears when it is assembled with a substrate. FIG. 9 is a cross-sectional view for schematically illustrating a completed member with skin that is manufactured by the present process for manufacturing member with skin according to Example No. 3.

The manufacturing process for member with skin according to Example No. 3 was carried out in the same manner as the manufacturing process for member with skin according to Example No. 1, except that the skin 2 and cushioning member 3 were made of TPO, a soft material, and that the cushioning member 3 comprised a porous or sponge-shaped mass.

The skin 2 and cushioning member 2 were made integrally by injection molding (or foam molding especially) using TPO as a soft material. Accordingly, the skin 2 and cushioning member 3 made an integrally-molded product, which comprised a foam-molded body. Moreover, of all the sections of a skin-molding die (not shown) for molding the skin 2 and cushioning member 3, the sections for molding the cushioning member 3 made movable dies that were disposed movably with respect to the other sections. In the course of molding the skin 2 and cushioning member 3, a molten TPO material was first injected into the skin-molding die. Then, immediately after injecting the molten TPO material, the movable dies were moved in directions getting away from the other stationary die for molding the skin 2. As a result, of all the molten TPO material, a part of the molten TPO material that was present near the movable dies, namely, a part of the molten TPO material that turned into the cushioning member 3, underwent foaming. On the other hand, the other part of the molten TPO material that was present away from the movable dies, namely, the other part of the molten metal that turned into the skin 2, did not undergo foaming. Consequently, within the integrally-molded product of the skin 2 and cushioning member 3 that the manufacturing process for member with skin according to Example No. 3 produced, the cushioning member 3 was molded as a porous or sponge-shaped mass, but the skin member 2 was not molded as a porous or sponge-shaped mass.

As illustrated in FIG. 8, when the molding step was completed, the cushioning member 3 comprised a dent 31 with cut-down wall thickness. The dent 31 was made by cutting down the cushioning member 3 annularly to a predetermined wall thickness at the molding step, as shown in the drawing. As a result, it was easy for an assembly worker or robot to let the cushioning member 3 undergo the opposite concavity/convexity reversal together with the skin member 2 at the assembling step. Moreover, as illustrated in FIG. 9, the cushioning member 3 filled up the intervening space between the skin 2 and the substrate 1 when the assembling step was completed. Hence, the cushioning member 3 gave the finished member with skin a sense of soft usability.

The manufacturing process for member with skin according to Example No. 3 enabled an assembly worker or robot to assemble the skin 2, which was molded as a configuration that had undergone concavity/convexity reversal from the configuration at the time of completed assemblage, with the substrate 1, while carrying out the opposite concavity/convexity reversal of the skin 2, that is, while turning the molded configuration of the skin 2 inside out, in the same manner as the manufacturing process for member with skin according to Example No. 1. Therefore, it is possible for manufacturers to inexpensively manufacture member with skin that demonstrates good decorativeness by means the manufacturing process for member with skin according to Example No. 3. Moreover, it is possible for manufacturers to give the member with skin according to Example No. 3 good decorativeness with ease as well as to manufacture it at reduced cost. In addition, not only it is possible for manufacturers to manufacture the skin 2 according to Example No. 3 less expensively, but also it is possible for them to manufacture the skin 2 that is good in terms of assemblage readiness to the substrate 1 as well as in terms of decorativeness.

### Example No. 4

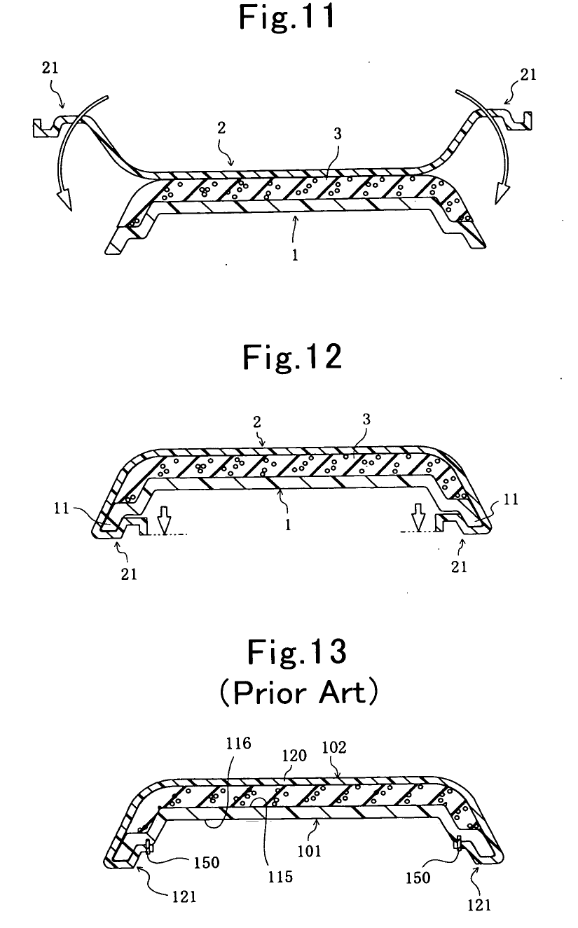

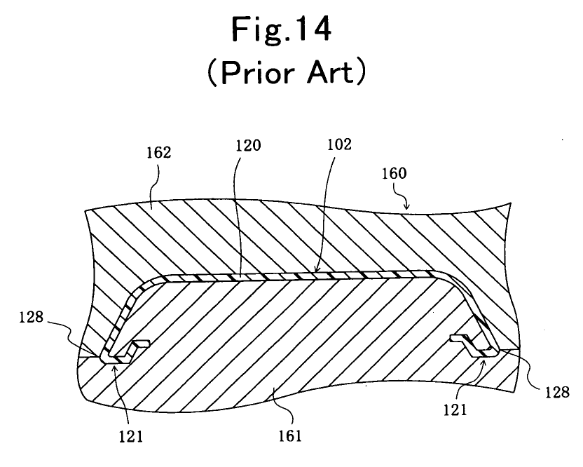

A process for manufacturing member with skin according to Example No. 4 of the present invention is provided with above-described optional features (1), (2), and (4). FIGS. 10 through 12 show explanatory diagrams for illustrating the present process for manufacturing member with skin according to Example No. 4. Specifically, FIG. 10 is a cross-sectional view for schematically illustrating how a cushioning member appears when it is put onto a substrate. FIG. 11 is a cross-sectional view for schematically illustrating how a skin appears when it is assembled with the substrate. FIG. 12 is a cross-sectional view for illustrating a completed member with skin that is manufactured by the present process for manufacturing member with skin according to Example No. 4.

The manufacturing process for member with skin according to Example No. 4 is distinct from the manufacturing process for member with skin according to Example No. 1 in that the skin 2 and the cushioning member 3 are made of different materials one another, and in that the cushioning member 3 is made independently of the skin 2 and substrate 1.

In the manufacturing process for member with skin according to Example No. 4, the skin 2 was made of a soft material, such as TPO or PVC. The cushioning member 3 was made of another soft material, TPU, to make a porous or sponge-shaped mass. Note that the skin 2 was molded as the same configuration as that of the skin 2 in the manufacturing process for member with skin according to Example No. 1, except that it was molded independently of or was free from the cushioning member 3.

In the manufacturing process for member with skin according to Example No. 4, the substrate 1, the skin 2, and the cushioning member 3 were molded separately or one by one, and were then assembled with each other to integrate them. That is, the substrate 1 was first assembled with the cushioning member 3, as shown in FIG. 10. Then, the integrated subassembly of the substrate 1 and cushioning member 3 was assembled with the skin 2, as shown in FIGS. 11 and 12.

In the manufacturing process for member with skin according to Example No. 4, an assembly worker or robot subjected the skin 2, which had been molded as a configuration that had undergone concavity/convexity reversal from its configuration at the time of completed assemblage, to the opposite concavity/convexity reversal at the assembling step, that is, an assembly worker or robot reversed the molded skin 2 inside out at the assembling step. Thus, in the same manner as the manufacturing process for member with skin according to Example No. 1, the assembly worker or robot assembled the skin 2 with the integrated subassembly of the substrate 1 and cushioning member 3 while subjecting the skin 2 to the opposite concavity/convexity reversal or reversing it inside out. Therefore, the manufacturing process for member with skin according to Example No. 4 enabled an assembly worker or robot to efficiently manufacture the member with skin that demonstrated good decorativeness in the same manner as the manufacturing process for member with skin according to Example No. 1. Further, not only the member with skin according to Example No. 4 demonstrated good decorativeness, but also it could be manufactured at reduced cost. Furthermore, in addition to the advantages that the skin 2 according to Example No. 4 was not only good in terms of decorativeness but also could be manufactured less expensively, the skin 2 produced assemblage readiness when an assembly worker or robot assembled it with the substrate 1. Moreover, the manufacturing process for member with skin according to Example No. 4 allowed a higher degree of freedom in the selection of material and/or configuration for the skin 2 and cushioning member 3, because the skin 2 and cushioning member 3 were molded independently of each other or were molded separately one by one.

Note that it is allowable to form a substrate that is directed to the manufacturing process for member with skin according to the present invention as the other configurations, such as plate-shaped configurations, for instance, even though the substrate 1 in the manufacturing process for member with skin according to Example Nos. 1 thorough 4 is molded as an inverted substantially-box-shaped configuration. If such is the case, since the skin covers the substrate's surfaces, namely, the substrate's top and side surfaces, the skin comprises: the covering portion for covering the substrate's top surface and side surfaces internally, covering portion which is formed as a convexed planar shape before being assembled with the substrate; and the exposed portion for covering the substrate's top surface and side surfaces externally, exposed portion which is formed as a concaved planar shape before being assembled with the substrate. Moreover, in this instance as well, the skin is likewise capable of undergoing the opposite concavity/convexity reversal in the course of being assembled with the substrate.

Moreover, although the cushioning member 3 in the manufacturing process for member with skin according to Example Nos. 1 through 3 is molded integrally with the skin 2, it is allowable to mold a cushioning member that is directed to the manufacturing process for member with skin according to the present invention independently of a skin as described in above Example No. 4. Note that, depending on a material for making the substrate 1, it is allowable to mold the cushioning member 3 integrally with the substrate 1.

In addition, although the anchoring portions 22 comprise a plurality of divided minor segments in the manufacturing process for member with skin according to Example Nos. 1 through 4, it is allowable to mold an integral anchoring portion as such a configuration that is disposed in succession to and all around the periphery of the skin's concaved exposed surface at the step of molding. On this occasion, the resulting skin is much less likely to come off from the substrate, because such a skin can keep its assembled configuration with high reliability.

The manufacturing process for member with skin according to the present invention can avail itself of manufacturing processes for lids for console box, seats for motorbike or bicycle, hoods for meter or meter cluster, outers for glove box, bodies for instrumental panel, various garnishes that pillar garnishes represent, and armrests.

Having now fully described the present invention, it will be apparent to one of ordinary skill in the art that many changes and modifications can be made thereto without departing from the spirit or scope of the present invention as set forth herein including the appended claims.

What is claimed is:

1. A process for manufacturing member with skin, the member comprising:
a substrate comprising a front surface, and a rear surface being disposed back-to-back to the front surface and having a periphery;
a skin comprising a covering portion for covering the substrate on a side of the front surface, and an anchoring portion for engaging with the periphery of the rear surface of the substrate;
the covering portion having a covering surface being formed as a concaved planar shape and facing the front surface of the substrate, an exposed surface being formed as a convexed planar shape and being disposed back-to-back to the covering surface, and a periphery;
the anchoring portion being disposed successively to the periphery of the covering portion, and extending inward toward the covering portion; and
the skin being made of soft material, and being molded independently of the substrate;
the process comprising the steps of:
molding the skin, wherein the skin is molded so that the covering surface is formed as a convexed planar shape, the exposed surface is formed as a concaved planar shape and the anchoring portion is placed more outward than the periphery of the covering portion lies, and a molding die for molding the skin is used, the molding die being provided with a die-parting line at a part thereof for molding the anchoring portion at least; and
assembling the skin with the substrate, wherein the skin undergoes concavity/convexity reversal so that the covering surface is formed as a concaved planar shape, the exposed surface is formed as a convexed planar shape and the anchoring portion extends inward from the periphery of the covering portion.

2. The process according to claim 1, wherein the skin is made of at least one soft material being selected from the group consisting of thermoplastic polyolefine (TPO), polyvinyl chloride (PVC) and thermoplastic polyurethane (TPU).

3. The process according to claim 1, wherein the anchoring portion is molded as a configuration that extends outward from the periphery of the covering portion at the step of molding the skin.

4. The process according to claim 1, wherein:
the member further comprises an inner member being independent of the substrate and the skin; and
the anchoring portion of the skin is held between the inner member and the substrate.

5. The process according to claim 1, wherein the member further comprises:
a space disposed between the skin and the substrate; and
an elastically-deformable cushioning member intervening between the skin and the substrate in the space.

6. The process according to claim 5, wherein the cushioning member is molded integrally with the skin at the step of molding the skin.

7. A member with skin, the member comprising:
a substrate comprising a front surface, and a rear surface being disposed back-to-back to the front surface and having a periphery;
a skin comprising a covering portion for covering the substrate on a side of the front surface, and an anchoring portion for engaging with the periphery of the rear surface of the substrate;
the covering portion having a covering surface being formed as a concaved planar shape and facing the front surface of the substrate, an exposed surface being formed as a convexed planar shape and being disposed back-to-back to the covering surface, and a periphery;
the anchoring portion being disposed successively to the periphery of the covering portion, and extending inward toward the covering portion; and
the skin being made of soft material, and being molded independently of the substrate;
wherein, before being assembled with the substrate, the skin comprises:
the covering portion whose covering surface is formed as a convexed planar shape, and whose exposed surface is formed as a concaved planar shape; and
the anchoring portion being placed more outward than the periphery of the covering portion lies.

8. The member according to claim 7, wherein the skin is made of at least one soft material being selected from the group consisting of thermoplastic polyolefine (TPO), polyvinyl chloride (PVC) and thermoplastic polyurethane (TPU).

9. The member according to claim 7, wherein the anchoring portion of the skin is free from any visible parting line that results from molding die for the skin.

10. The member according to claim 7, wherein the anchoring portion of the skin is provided with a visible parting line, which results from molding die for the skin, at a free end thereof.

11. A skin for member with skin, the member comprising:
a substrate comprising a front surface, and a rear surface being disposed back-to-back to the front surface and having a periphery;
a skin comprising a covering portion for covering the substrate on a side of the front surface, and an anchoring portion for engaging with the periphery of the rear surface of the substrate;
the covering portion having a covering surface being formed as a concaved planar shape and facing the front surface of the substrate, an exposed surface being formed as a convexed planar shape and being disposed back-to-back to the covering surface, and a periphery;
the anchoring portion being disposed successively to the periphery of the covering portion, and extending inward toward the covering portion; and
the skin being made of soft material, and being molded independently of the substrate;
wherein, before being assembled with the substrate, the skin comprises:
the covering portion whose covering surface is formed as a convexed planar shape, and whose exposed surface is formed as a concaved planar shape; and
the anchoring portion being placed more outward than the periphery of the covering portion lies.

12. The skin according to claim 11, wherein the skin is made of at least one soft material being selected from the group consisting of thermoplastic polyolefine (TPO), polyvinyl chloride (PVC) and thermoplastic polyurethane (TPU).

13. The skin according to claim 11, wherein the anchoring portion is free from any visible parting line that results from molding die for the skin.

14. The skin according to claim 11, wherein the anchoring portion of the skin is provided with a visible parting line, which results from molding die for the skin, at a free end thereof.
